(19) United States
(12) Patent Application Publication
(10) Pub. No.: US 2001/0029899 A1
(43) Pub. Date: Oct. 18, 2001

(54) Hummingbird feeder

(76) Inventor: William Arlitt, Poteet, TX (US)

Correspondence Address: Michelle L. Evans, Gunn, Lee & Keeling, Suite 1500, 700 N. St. Mary's Street, San Antonio, TX, 78205, US

(21) Appl. No.: 09/749,855

(22) Filed: Dec. 27, 2000

Related U.S. Application Data
(60) Provisional application No. 60/173,429, filed on Dec. 29, 1999.

(51) Int. Cl. A01K 7/00

(52) U.S. Cl. 119/77

(57) ABSTRACT

A hummingbird feeder than can be disassembled for cleaning is shown. The hummingbird feeder has simple components so that the components are unlikely to become displaced during cleaning. The hummingbird feeder generally comprises of a basin attached to and surrounded by a perch. A cover is placed on top of the basin. The cover has a plurality of feeding ports to allow hummingbirds access to the sugar solution. A neck and a bottle connector are located inside the basin. A bottle is threadedly attached to the bottle connector through a bottling port located on the cover. Securing the bottle to the bottle connector also secures the cover to the basin. The bottle connector is manufactured separately and then sonic fused to a neck located at the basin, thus creating a plurality of ports for the sugar solution to flow from the bottle to the basin. This two step method of forming the bottle connector separate from the basin and the neck and then fusing the bottle connector to the neck allows the easily cleanable design of the basin to be injection molded.

This application claims priority under 35 U.S.C. § 120 to U.S. Provisional Application No. 60/173,429 filed Dec. 29, 1999.

### BACKGROUND OF THE INVENTION

1. Field of the Invention

Applicant's invention relates to bird feeders, and more specifically, hummingbird feeders.

2. Background Information

Hummingbirds survive on nectar. Bird watchers who want to observe hummingbirds often use hummingbird feeders filled with a sugar solution to attract these birds. Unfortunately, in addition to attracting hummingbirds, the sugar solution in the feeders often also attract bees and ants. Too many bees and ants around a hummingbird feeder will drive away the hummingbirds. The bees and ants are also likely to sting the human observers. Therefore, various hummingbird feeders have been designed to allow hummingbirds to reach the sugar solution, while, at the same time, prevent bees and ants from reaching the sugar solution.

Hummingbird feeders that can prevent bees and ants from reaching the sugar solution usually have generally the same type of design. These feeders usually have a reservoir that can hold a certain amount of sugar solution. The reservoir consists of a cover and a basin, with the cover sealing the sugar solution inside the basin. A plurality of small holes are drilled through the cover so that a hummingbird can insert it's beak into the hole to reach the sugar solution. A fixed amount of sugar solution is placed in the reservoir. However, the reservoir is never completely filled. Rather, a certain amount of space is left between the sugar solution and the cover. This space prevents bees from reaching the sugar solution without hindering hummingbirds from reaching the sugar solution. This type of hummingbird feeder design is commonly used in the market place.

One of the most common problems faced by the type of hummingbird feeder described above is that the feeder is difficult to clean. The sugar solution in the feeder, if not cleaned properly, will ferment and cause mold or mildew to grow. The fermented sugar solution, the mold, and the mildew, when consumed by hummingbirds, will cause the hummingbirds to become sick and die. Thus, this type of hummingbird feeder must be cleaned periodically.

Some hummingbird feeders such as disclosed by U.S. Pat. No. 3,913,527, U.S. Pat. No. 4,691,665, and U.S. Pat. No. 5,454,348 have reservoirs with covers fused to the reservoirs. These feeders are difficult to clean because their design do not allow, or allow inadequate, space for human hands to reach inside the feeder to wipe away the mold or mildew.

While various other designs such as those disclosed in U.S. Pat. No. 5,062,390 or U.S. Pat. No. 5,269,258 have removable covers to allow easy cleaning, these hummingbird feeders can only hold a limited amount of sugar solution within the reservoir. Thus, these designs are not ideal because they require frequent refills of sugar solution.

To solve the need to frequently refill the reservoir, an inverted bottle containing sugar solution is often used to house more sugar solution than the amount that can be held within the reservoir itself. U.S. Pat. No. 3,292,589 and U.S. Pat. No. 4,938,168 disclose this type of hummingbird feeder. However, these feeders have certain areas that are difficult to clean. Therefore, these feeders are likewise not ideal hummingbird feeders.

U.S. Pat. No. 2,267,883 and U.S. Pat. No. 5,303,674 both disclose hummingbird feeders using a bottle to store extra sugar solution while being cleanable. Although the inside design of the reservoir in U.S. Pat. No. 2,267,883 is easy to clean, the cover is secured to the base using a screw. The screw causes the removal of the cover from the reservoir to be difficult and time consuming. Therefore, U.S. Pat. No. 2,267,883 is not an ideal design. Finally, although U.S. Pat. No. 5,303,674 discloses a hummingbird feeder that can easily be taken apart and easily cleaned, this feeder contains too many removable parts so that a person can easily misplace a part of the hummingbird feeder while cleaning the feeder. Thus, the design of U.S. Pat. No. 5,303,674 can also be improved.

### SUMMARY OF THE INVENTION

It is an object of the present invention to provide a novel and easily cleanable humming bird feeder that will prevent bees and ants from reaching the sugar solution.

It is another object of the present invention to provide a hummingbird feeder that will prevent bees and ants from reaching the sugar solution while having very few removable parts so that the parts will not become lost or misplaced during cleaning.

It is another object of the present invention to provide an easily cleanable hummingbird feeder that uses a bottle as additional storage space for the sugar solution used to feed hummingbirds.

It is another object of the present invention to provide an easily cleanable hummingbird feeder that can be quickly and inexpensively manufactured through plastic injection molding.

In satisfaction of these and related objectives, Applicant's invention provides a hummingbird feeder generally comprising a basin, a perch, a cover, and a bottle. The perch encircles and is attached to the basin through a plurality of connector flanges. A neck is located generally in the center of the basin. A bottle connector is attached on to the neck. The bottle connector is threaded on its inside circumference to allow attachment to the bottle. The cover is removably attached to the basin. A plurality of feeding ports are located on the cover along with a generally centrally located bottle port. The bottle port allows the bottle to pass through the cover and to attach to the bottle connector.

The bottle has a mouth that is threaded. An O-ring is placed generally near the mouth of the bottle to prevent leakage of the sugar solution. The bottle is attached to a hanger to allow the hummingbird feeder to be hung in the yard.

The entire reservoir can be quickly and inexpensively built by using plastic injection molding techniques. The perch, the basin, and the neck in the basin are formed together, the bottle connector is formed by itself, and the cover is formed by itself. To assemble the reservoir, the bottle connector is simply fused to the neck. This fusing step allows the easily cleanable design of the basin to be formed by plastic injection molding.

Applicant's invention permits is practitioner to easily clean the hummingbird feeder while preventing ants and bees from reaching the feeder and while providing a large amount of sugar solution in the feeder.

### BRIEF DESCRIPTION OF THE DRAWINGS

FIG. 1 is a perspective view of the preferred embodiment of the present invention without the bottle.

FIG. 2 is a exploded perspective view of the preferred embodiment of the present invention.

FIG. 3 is a perspective view of the bottle of the present invention.

### DETAILED DESCRIPTION OF THE PREFERRED EMBODIMENT

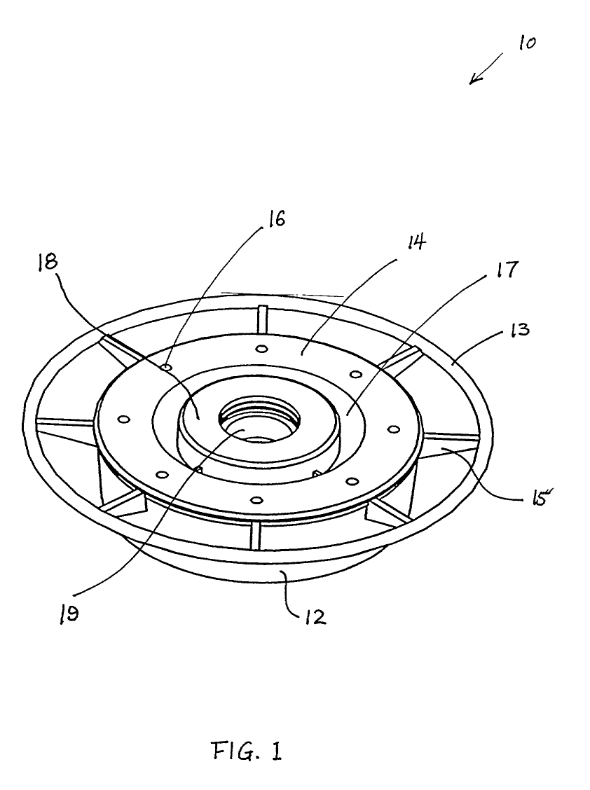

The present invention, a hummingbird feeder 10, consists of two primary parts: a bottle 23 and a reservoir 11. Reservoir 11 of hummingbird feeder 10 is shown in FIG. 1.

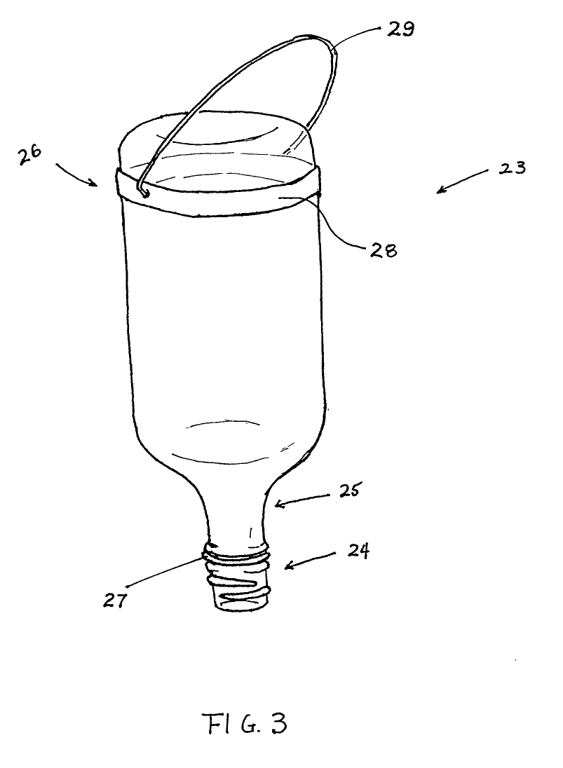

FIG. 3 is a perspective view of bottle 23 of the present invention. Bottle 23 can be made of any material that can contain a liquid. Bottle 23 may also be transparent. In the preferred embodiment, bottle 23 is made of glass. Bottle 23 consists of a mouth 24, a neck 25, and a base 26. Mouth 24 of bottle 23 is threaded for attachment to reservoir 11. An O-ring 27 is located between two raised portions near mouth 24. O-ring 27 is to prevent leakage of the sugar solution. Finally, near base 26 of bottle 23, a metal loop 28 is used to secure a length of wire 29 to bottle 23, thus allowing bottle 23 to be hung outside to attract hummingbirds.

FIG. 1 shows reservoir 11 of hummingbird 10. Reservoir 11 is generally comprised of a basin 12, a perch 13, and a cover 14. Reservoir 11 can be made of any rigid material. In the preferred embodiment, reservoir 11 is made of plastic. Basin 12 has a predetermined depth and can be of any shape. However, in the preferred embodiment, basin 12 is circular.

Perch 13 is connected to and encircles basin 12. Perch 13 can be of any shape in cross section as long as perch 13 is adequately sized to be gripped by hummingbird feet. In the preferred embodiment, perch 13 is circular in cross section. Perch 13 is located a predetermined distance away from basin 12, at a place where the perched hummingbird can reach the sugar solution inside reservoir 11. In the preferred embodiment, perch 13 is located near the top of basin 12, at generally the place where cover 14 is attached to basin 12. A plurality of connector flanges 15 connect perch 13 to basin 12.

Cover 14 is removably attached to basin 12. Cover 14 can be of any shape as long as cover 14 completely covers basin 12. In the preferred embodiment, cover 14 is circular. A plurality of feeding ports 16 are located a predetermined distance away from the circumference of cover 14. Feeding ports 16 are orifices passing through the entire cover 14. Feeding ports 16 are sized to allow the beaks of hummingbirds to be inserted into reservoir 11 to reach the sugar solution stored inside reservoir 11.

A recess 17 is located on cover 14. The center of recess 17 generally coincides with the center of cover 14. Recess 17 lowers the level of the mouth of the bottle to a predetermined distance below the top of basin 12. Since the level of sugar solution will be at the same level of the mouth of the bottle, recess 17 effectively creates a space between the sugar solution and the top of basin 12. This space prevents bees and ants from reaching the sugar solution.

A bottle housing 18 is also located on cover 14. The center of bottle housing 18 coincides with the center of cover 14. Bottle housing 18 rises upward for a predetermined distance from recess 17.

Bottle port 19 is located generally at the center of bottle housing 18. Bottle port 19 is an orifice that allows the mouth of the bottle to threadedly connect to a bottle connector 20.

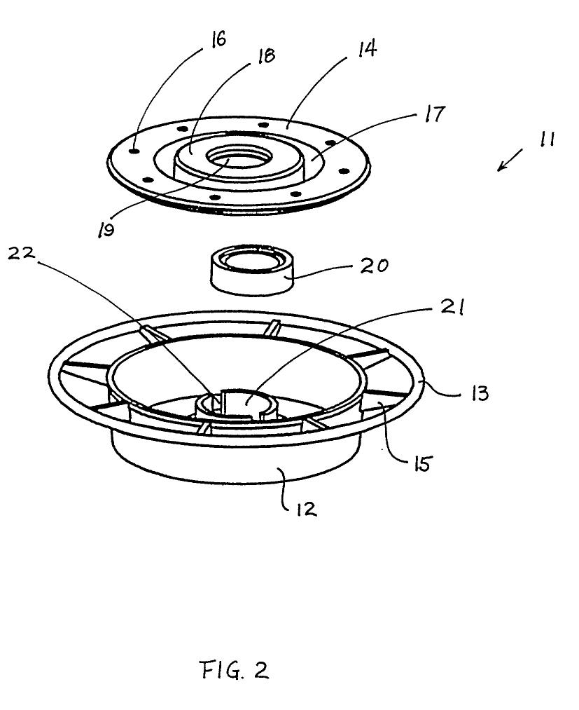

FIG. 2 shows an exploded perspective view of reservoir 11. Bottle connector 20 is shown in FIG. 2. Bottle connector 20 is generally a ring having a certain depth. The inner circumference of bottle connector 20 is threaded to allow attachment to mouth 24 of bottle 23. The bottom of bottle connector 20 is fixedly attached to neck 21. In the preferred embodiment, bottle connector 20 is sonic fused to neck 21. A slightly raised ridge (not shown) at the bottom of bottle connector 20 enables bottle connector 20 to be easily and correctly lined up with neck 21 before fusing.

Neck 21 is located inside and generally at the center of basin 12. Neck 21 has generally the same circumference as bottle connector 20. A plurality of sugar solution ports 22 are located on neck 21. In the preferred embodiment, there are two sugar solution ports 22. Sugar solution ports 22 allow the sugar solution from bottle 23 to flow in to basin 12. Other than neck 21, the inside of basin 12 is smooth and uncluttered by other features.

To use hummingbird feeder 10, bottle 23 is first filled with sugar solution. Then, cover 14 is placed on top of basin 12. At this point, cover 14 is not secured to basin 12 and can be removed from basin 12 simply by lifting cover 14 away from basin 12. With cover 14 on top of basin 12, the entire reservoir 11 is flipped upside down. Mouth 24 of bottle 23 is then threadedly attached to reservoir 11 by inserting mouth 24 into bottle port 19 and threadedly attaching mouth 24 to bottle connector 20. Once bottle 23 is attached to reservoir 11, cover 14 is wedged between the bottle and bottle connector 20, thereby securing cover 14 to basin 12. Reservoir 11 is then flipped to its upright position while, simultaneously, bottle 23 is flipped to an upside down position. The sugar solution now flows from the bottle to reservoir 11, partially filling reservoir 11. Hummingbird feeder 10 is now ready to be placed outside for feeding.

When hummingbird feeder 10 must be cleaned, the bottle is first removed from reservoir 11. Removing the bottle also releases cover 14 from basin 12. Cover 14 now can be removed and both the inside of basin 12 and the entire cover 14 can be easily cleaned.

Hummingbird feeder 10 is manufactured through injection molding techniques. Basin 12, perch 13, connector flanges 15, and neck 21 are formed as one piece. Bottle connector 20 is injection molded as a separate piece. Finally, cover 14 is molded as one piece. After molding, bottle connector 20 is sonic fused to neck 21. The sonic fusing step forms sugar solution ports 22. This two-step method of forming bottle connector 20 separate from basin 12 and neck 21 and then fusing bottle connector 20 to neck 21 allows the easily cleanable design of basin 12 to be injection molded.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A hummingbird feeder for dispensing sugar solution to hummingbirds comprising:
a bottle having a mouth attached to a base by way of a first neck wherein an O-ring is placed adjacent said mouth to prevent leakage of said sugar solution to prevent attraction to bees and ants; and
a reservoir removably attached to said bottle, said reservoir comprising a basin and a cover attached to a perch, wherein said cover comprises a plurality of feeding ports of adequate size to allow the beaks of hummingbirds to be inserted therein, and a recess adjacent said cover to lower the level of said mouth of said bottle below a top of said basin to create a space between said sugar solution and said top of said basin to prevent attraction to bees and ants.

2. The hummingbird feeder of claim 1 further comprising a bottle connector within said reservoir for receiving said mouth of said bottle for attachment.

3. The hummingbird feeder of claim 2 wherein said bottle connector is fixedly attached to a second neck within said reservoir at the center of said basin.

4. The hummingbird feeder of claim 3 wherein said second neck comprises a plurality of sugar solution ports.

5. A hummingbird feeder for dispensing sugar solution to hummingbirds comprising:
a bottle having a mouth attached to a base by way of a first neck wherein an O-ring is placed adjacent said mouth to prevent leakage of said sugar solution to prevent attraction to bees and ants;
a first portion comprising a flat circular cover attached by way of a recess to a bottle housing, said bottle housing containing an opening for insertion of said bottle and said cover comprising a plurality of feeding ports of adequate size to allow the beaks of hummingbirds to be inserted therein, wherein said recess is adjacent said cover to lower the level of said mouth of said bottle below a top of a basin to create a space between said sugar solution and said top of said basin to prevent attraction to bees and ants; and
a second portion comprising said basin attached to a circular perch by way of a plurality of flanges, whereby said second portion is attached to said first portion to define a fluid reservoir.

6. The hummingbird feeder of claim 5 further comprising a bottle connector located between said first portion and said second portion for receiving said mouth of said bottle for attachment.

7. The hummingbird feeder of claim 6 wherein said bottle connector is fixedly attached to a second neck within said basin.

8. The hummingbird feeder of claim 7 wherein said second neck comprises a plurality of sugar solution ports.
